(19) United States
(12) Patent Application Publication
(10) Pub. No.: US 2002/0151266 A1
(43) Pub. Date: Oct. 17, 2002

(54) Slicing and poultry deboning device

(76) Inventors: Margo Kidushim, LaCanada, CA (US); Ralph M. Kidushim, LaCanada, CA (US)

Correspondence Address: Margo Kidushim, 4313 Chevy Chase Dr., LaCanada, CA, 91011, US

(21) Appl. No.: 09/835,214

(22) Filed: Apr. 14, 2001

(51) Int. Cl. A22C 17/02

(52) U.S. Cl. 452/135

(57) ABSTRACT

This is a slicing device that is particularly intended for use as a poultry deboning device. The device includes a frame with a support ridge intended to support the medial portion of a poultry half breast. The ridge is preferably comprised of a raised annular ring that is adjustable in relation to a cutting blade that is movably mounted to the frame. Opposite to the support ridge is an item support. This applies force to an item positioned on the support ridge, maintaining its position thereon. The support ridge preferably includes a textured face and is movably mounted to the frame with a spring to bias the face toward the support ridge. The cutting blade is positioned between the support ridge and the item support. An item, such as a poultry breast, can be positioned with the medial, or rib side on the support ridge and secured thereon by the force applied by the item support, while the cutting blade slices through the breast, thereby separating the meat from the bones of the breast.

### BACKGROUND OF THE INVENTION

The invention herein relates to a kitchen utensil and more specifically to a slicing device and even more particularly to a deboning device for poultry.

Slicing devices have a variety of uses in the home and industry. Food preparation is one category of use. In regard to the process of separation of meat from bone, a variety of attempts have been made, most commonly in industry. Though efficient in view of mass production, this does little for the individual user who wishes to make chicken stir fry at home. Few if any devices address this need on the basis of an individual user. Purchasing poultry breast meat that has been deboned is considerably more expensive than with the ribs attached, even taking into account the weight of the later discarded bones.

Previous disclosures have been made which teach slicing devices, even some with some form of ability to secure the item to be cut. One such item is a bagel cutter as disclosed by Kensrue in U.S. Pat. No. 5,611,266. A movable blade is not taught but fixed guides to support the outside edges of the device to be cut and a user places their own knife between the gaps in these fixed guides. Their textured item support is fixed with respect to the eventual blade of the user's knife. This item is intended to be used to cut bagels, which are all relatively the same size and the fixed cutting supports are of relative unimportance in bagel cutting in that exact placement of the additional knife, used for cutting, is unimportant. In terms of slicing the meat from a chicken breast, where the bone portion will be discarded, the placement of the cutting blade is more critical. The goal is minimal meat remaining on the bone.

### SUMMARY OF THE INVENTION

Present Invention:

In one aspect, the invention features an item securing slicing device such as can be used as a poultry deboning device, the device including a frame with a support ridge which is preferably adjustable. An item support positioned opposite to the support ridge and a cutting blade is positioned between the support ridge and the item support, the blade being movably mounted to the frame.

The device may also include a handle that is mounted to the cutting blade, the handle and the blade being movably mounted to the frame by any of a variety of forms including a pivotal mounting or a slide mounting.

The frame may include a substantially hollow structure and a safety lid that is movably mounted to the structure. The previously noted handle can be positioned to interfere with the movement of the safety lid from an open position to a closed position.

The support ridge includes some form of a raised peripheral edge, preferably a raised annular ring. Within the peripheral edge, the support ridge can include an access hole, thus providing access to the cutting blade. An access door, which is preferably pivotally mounted to the frame, may be included to enable restriction of access to the cutting blade. As noted, the support ridge may also be adjustable in position relative to the cutting blade. This may be done by any means known in the art but preferably either by threaded adjustment or sliding adjustment.

The item support, of previous note, may include a substantially flat section, which may include a textured face such as a plurality of cleats, and a spring, which provides bias to the substantially flat section toward said cutting blade.

The cutting blade can take many forms including a serrated knife blade. The blade may be actuated by the previously noted handle or by use of a mechanical drive coupled to the cutting blade. The mechanical drive can be any form of drive including an electric motor, which actuates a roller, which in turn articulates with the cutting blade. The motor may actuate the roller by use of a gear drive. In this case, a spring that is mounted to the cutting blade, is used to provide recoil of the cutting blade when the roller is not in contact with the blade.

In another aspects, the invention includes a method of separating poultry breast meat from bone, which includes the steps of providing a device as previously noted, positioning the poultry breast on the support ridge and securing thereto by force applied by the item support; and then actuating the cutting blade. This enables cutting through the poultry breast, separating the breast meat from the bone. The process may also include the step of adjusting the position of the support ridge relative to the position of the cutting blade in order to allow for various breast sizes.

Definition of Terms:

Unless otherwise defined, all technical and scientific terms used herein have the same intended meaning as would be commonly understood by anyone of ordinary skill in the art to which this invention belongs.

BRIEF DESCRIPTION OF THE DRAWINGS

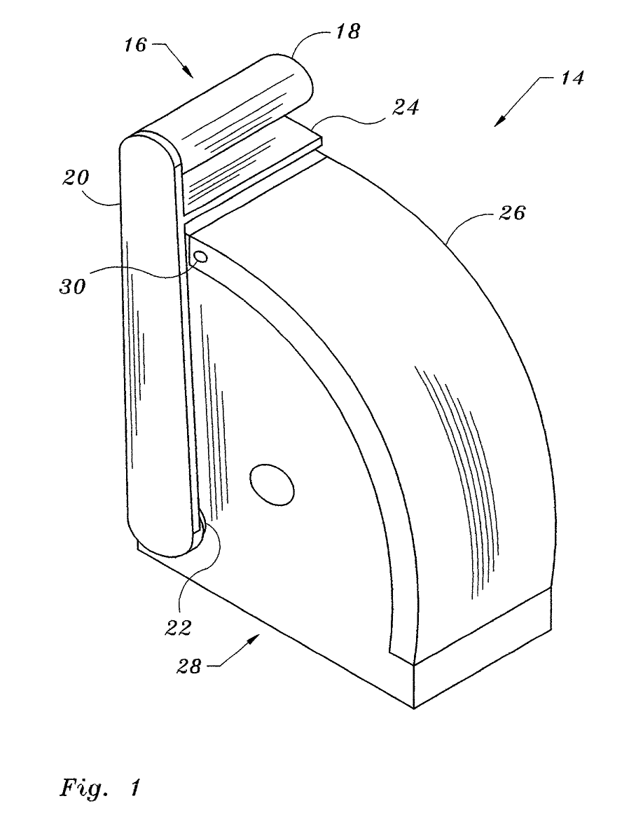

FIG. 1 is an isometric view of a slicing and deboning device with the safety lid in a closed position, the device produced in accordance with a preferred embodiment of the present invention.

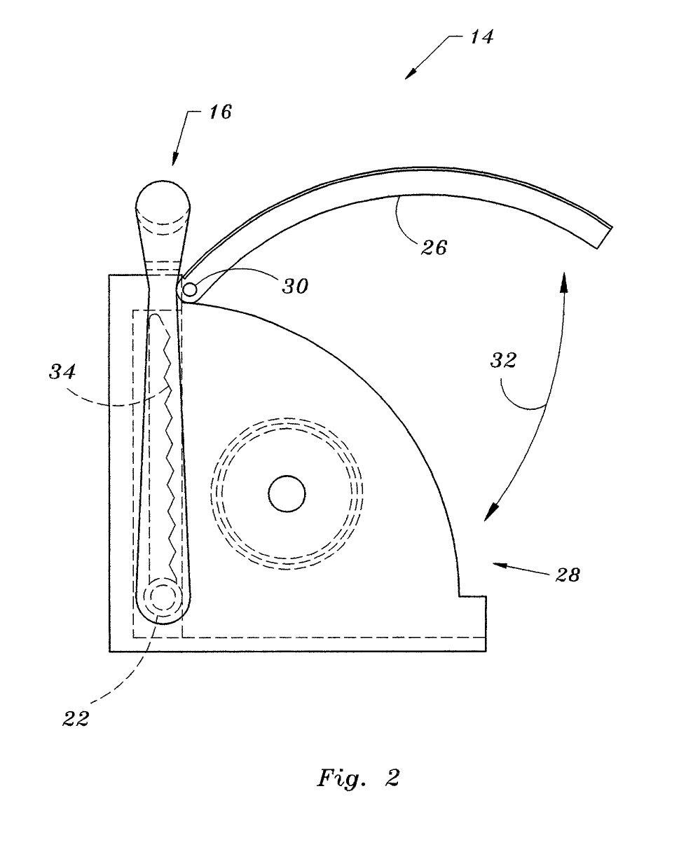

FIG. 2 is a side view of a slicing and deboning device with the safety lid in an open position, the device produced in accordance with a preferred embodiment of the present invention.

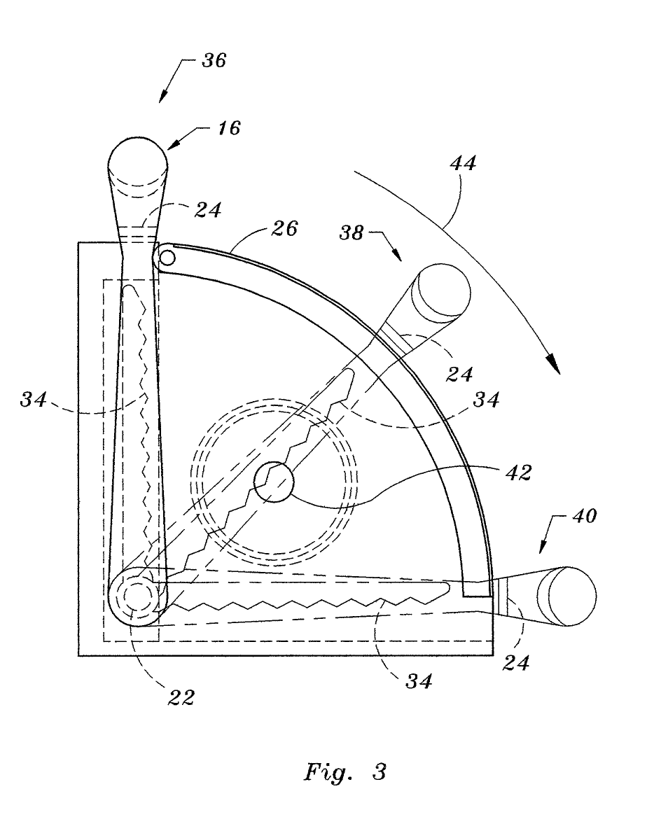

FIG. 3 is a side view of a slicing and deboning device with the safety lid in a closed position and showing the general operation of the device, the device produced in accordance with a preferred embodiment of the present invention.

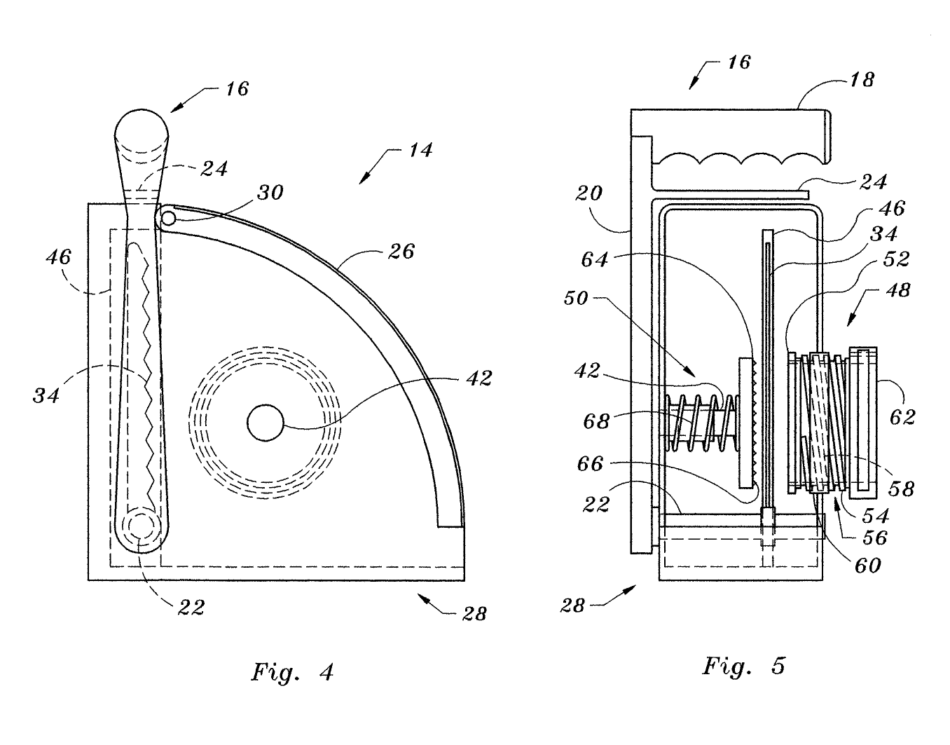

FIG. 4 is a side view of a slicing and deboning device with the safety lid in a closed position, the device produced in accordance with a preferred embodiment of the present invention.

FIG. 5 is a front view of a slicing and deboning device, looking through the safety lid and showing the internal elements of the device, the device produced in accordance with a preferred embodiment of the present invention.

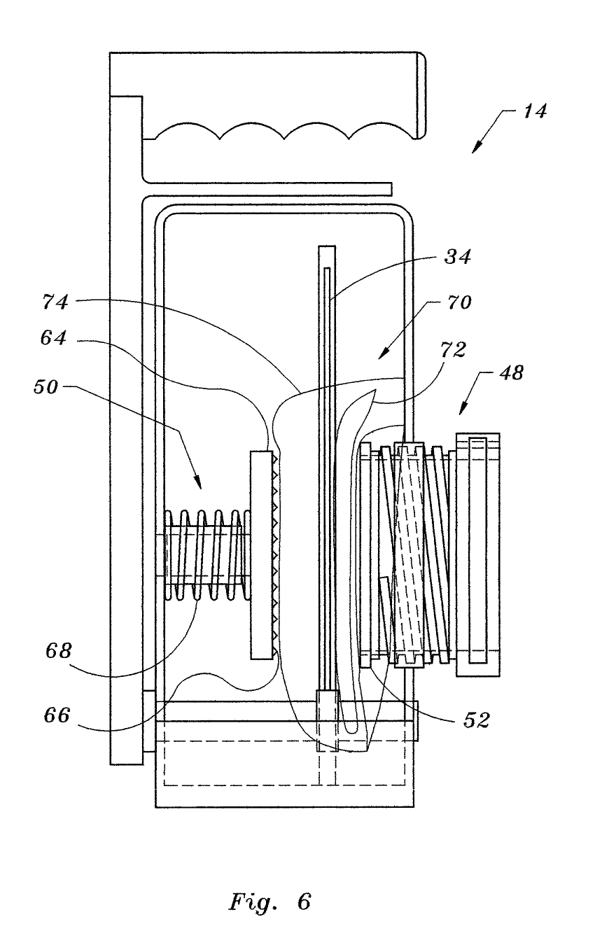

FIG. 6 is a front view of a slicing and deboning device, looking through the safety lid and showing the internal elements of the device in use with a chicken breast, the device produced in accordance with a preferred embodiment of the present invention.

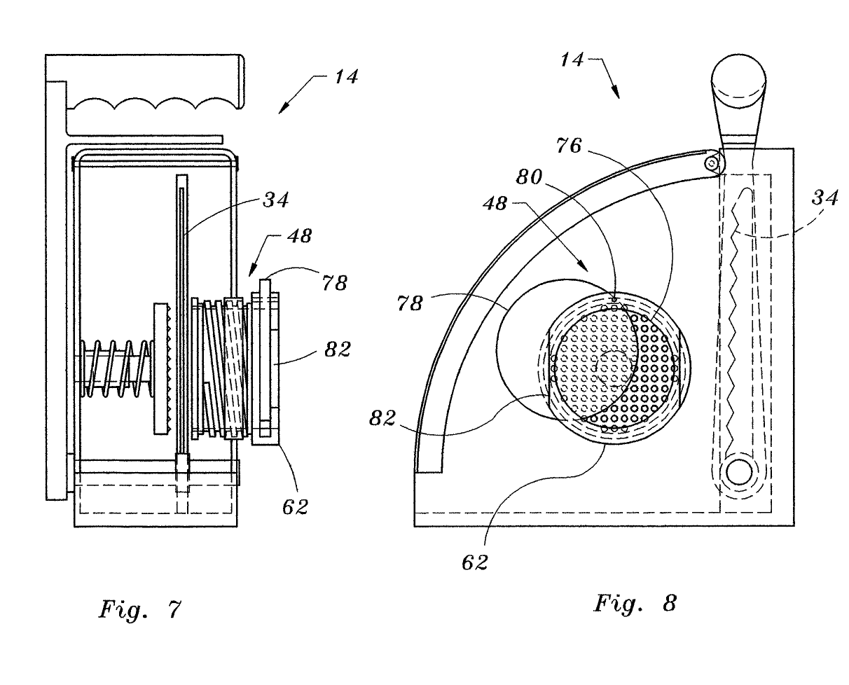

FIG. 7 is a front view of a slicing and deboning device, looking through the safety lid and showing the internal elements of the device with the access door in a partially open position, the device produced in accordance with a preferred embodiment of the present invention.

FIG. 8 is a side view of a slicing and deboning device, with the access door in a partially open position revealing the textured face of the item support, the device produced in accordance with a preferred embodiment of the present invention.

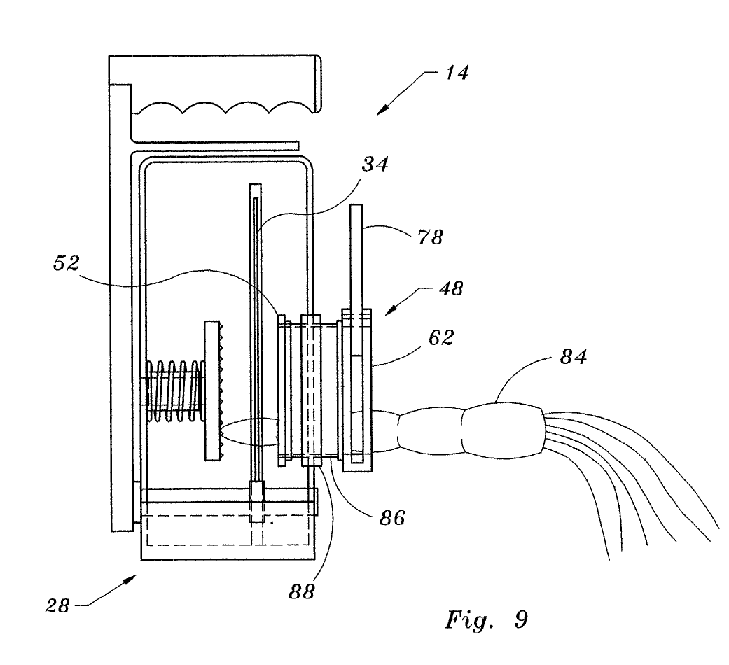

FIG. 9 is a front view of a slicing and deboning device, looking through the safety lid and showing the internal elements of the device with the access door in an open position and used as a slicer, the device produced in accordance with a preferred embodiment of the present invention.

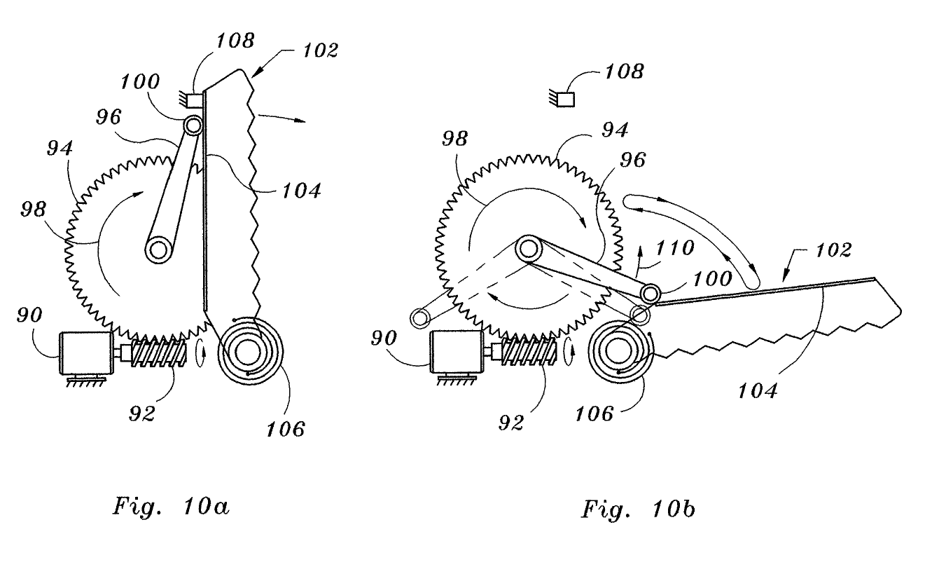

FIG. 10 is a side schematic view of a slicing and deboning device, showing an example of a motor driven cutting blade actuation system, the device produced in accordance with the preferred embodiment of the present invention.

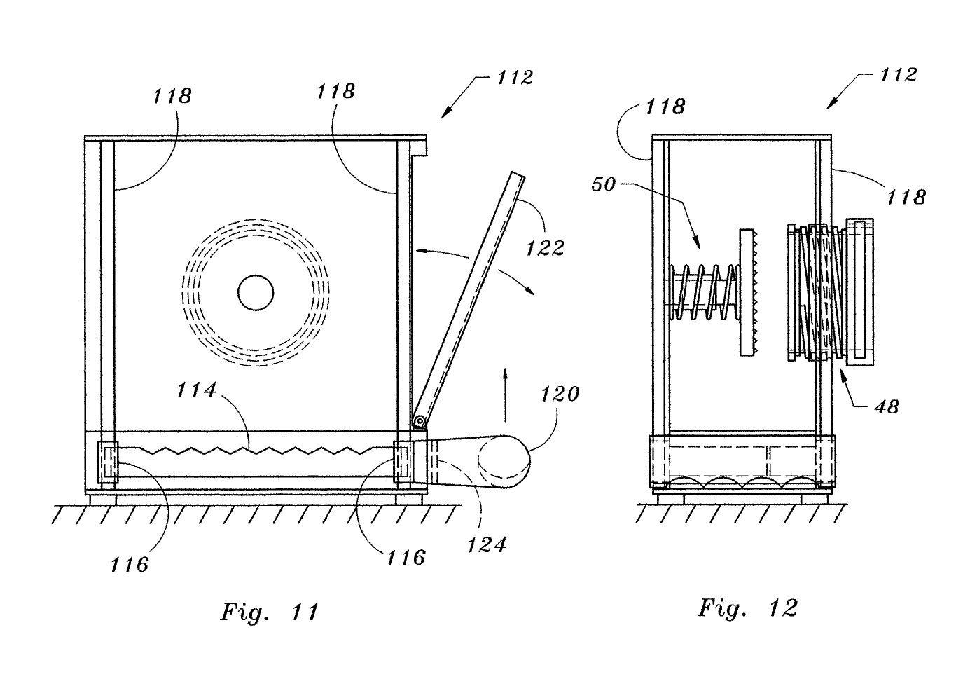

FIG. 11 is a side view of a slicing and deboning device with a slidably mounted cutting blade and handle, the device produced in accordance with the present invention.

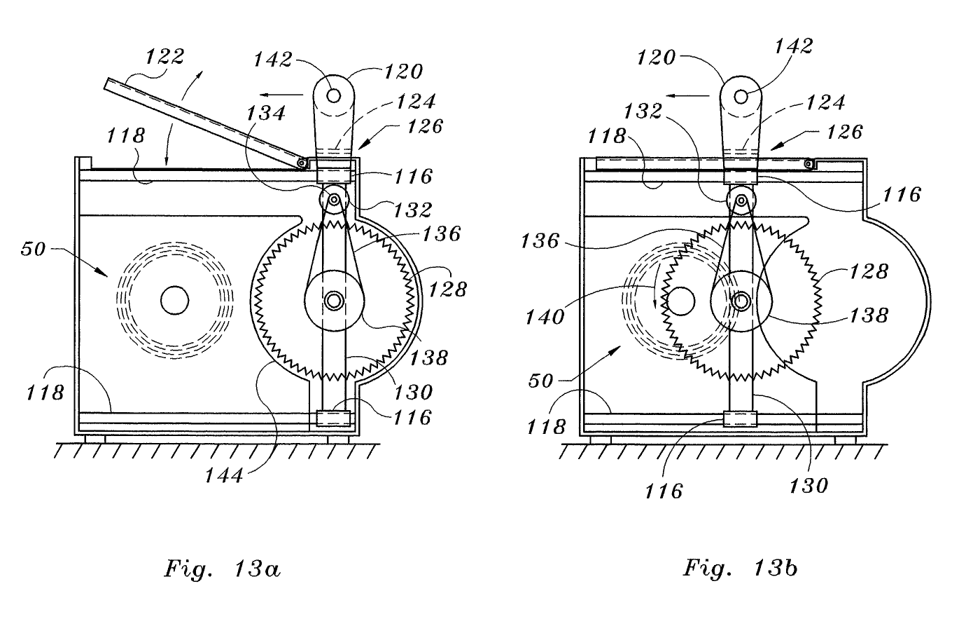

FIG. 12 is a front view of a slicing and deboning device with a slidably mounted cutting blade and handle and looking through the safety door, the device produced in accordance with the present invention.

FIG. 13 is a side view of a slicing and deboning device with a slidably mounted rotating cutting blade, the device produced in accordance with the present invention.

### DETAILED DESCRIPTION OF THE PREFERRED EMBODIMENT

The object of the disclosed invention is to provide an improved device and method of cutting items, particularly in the area of food preparation and more specifically in the area of separating poultry meat from the rib bones and the sternum of the bird.

What is shown in FIG. 1 is an isometric view of a slicing and poultry deboning device 14. In its simplest form, the invention includes a handle 16. The handle 16 is shown here to include a grip 18 that is grasped by the user, an arm 20 that connects the grip 18 to a pivot shaft 22, and a safety guard 24 that is rigidly mounted to the arm 20. The preferred embodiment of the device includes an arcuate safety lid 26 that is pivotally mounted to the frame 28 by a pin 30. This allows the lid 26 to articulate with the frame 28 to provide access to the internal portion of the frame 28 but only when the handle 16 is in this upright position. When the handle 16 is rotated down toward the lower right corner of the figure, the guard 24 causes an interference with the lid 26, preventing the lid 26 from opening.

The internal access is illustrated in FIG. 2. Here the safety lid 26 is in an elevated, or open position. The arrow 32 shows the relative path of movement of the lid 26, which pivots about the pin 30. It can also be seen here that the handle 16 must be in the upright position in order for the lid 26 to be opened. A cutting blade 34 is shown to be pivotally mounted to the frame 28 about the same shaft 22 as is used to articulate the handle 16 with the frame 28. Here this is accomplished by the cutting blade 34 being rigidly attached to the shaft 22 and thereby moving with the handle 16 relative to the frame 28.

The movement of the handle 16 and the cutting blade 34 are further illustrated in FIG. 3. Movement of the handle 16 and attached blade 34 from the upright position 36 to the midpoint position 38 and then to the bottom position 40 shows how the blade 34 is caused to move in this path past the support shaft 42, as depicted by the arrow 44. This view also clearly illustrates how the lid 26 cannot be opened while the blade 34 is in any position other than the upright position 36 due to the interference caused by the safety guard 24 to the lid 26.

Side and front views of the device 14 are shown in FIG. 4 and FIG. 5 respectively. Previously noted structures are labeled in a manner that is consistent with the prior disclosure to further assist the understanding of the device at it would appear in each view. This includes the presence of the handle 16, the safety guard 24, the combination attached to the cutting blade 34 by way of the shaft 22. The combination of both views, illustrated in these figures, show how the shield 46 receives the blade 34 when in the upright position. Since this is the only position of the handle 16, and therefore the blade 34, where the lid 26 is capable of being opened. This inaccessibility to the blade with the lid 26 opened prevents a user from being able to contact the blade 34, thus adding to the safety of the device.

With specific reference to FIG. 5, two additional aspects of the invention are disclosed. These aspects are the support ridge 48 and the item support 50. The support ridge 48 includes some form of a raised peripheral edge. The raised edge 52 has in this case taken the form of a raised annular ring, which is shown here. It should be noted that the round shape of the raised edge 52 is desirable for a number of reasons, but it is not critical to the invention. Oval, rectangular, square or any number of other shapes would also allow the raised edge 52 to function. In the preferred embodiment, as shown in this figure, the raised edge 52 is adjustable in its relative position to the blade 34. This can be accomplished by any number of methods common in the art including a threaded adjustment or sliding adjustment. The former is illustrated here with male threads 54 formed on the shank 56 of the support ridge 48 and female threads 58 on the frame bushing 60, which is rigid to the frame 28. By rotating the ridge handle 62, the ring 52 can be positioned closer to or further away from the blade 34. The item support is positioned opposite to the support ridge 48, with the blade 34 positioned there between. The item support includes a substantially flat face 64 and as shown here. That face can be textured by number of means and is shown here to be by a plurality of cleats 66. This face 64 is adjustable in its position relative to the blade and therefore the support ridge 48 by being slidably mounted to the frame 28 about the support shaft 42. A spring 68 is used to bias the face 64 toward the support ridge 48 (and therefore the blade 34 as well). This combination enables an item to be secured on the support ridge 48 by the force applied to the item by the item support 50.

A typical use of the device 14 is illustrated in FIG. 6. The raised edge 52 of the support ridge 48 supports the medial or rib side of a chicken breast 70. The sternum and ribs 72 are then located adjacent to the support ridge 48 and the meat 74 of the breast 70 contacts the flat surface 64 of the item support 50. The cleats 66, with the force offered by the spring 68, provide a high friction contact to aid in holding the breast 70 in place as the blade 34 slices the breast 70. This separates the breast 70 into a meat portion 74 and a bone portion 72.

An additional feature of the device 14 is shown as a front view in FIG. 7 and a corresponding side view in FIG. 8. In both figures an access hole 76 is provided through the support ridge 48, thus providing access to the blade 34 when the blade 34 is in a lowered position. Restriction to this hole 76 is made possible by the access door 78. This is movably mounted to the support ridge 48. In the preferred embodiment, the access door 78 is pivotally mounted by use of the pin 80 in the ridge handle 62, as is shown here. The specific form of attachment is not necessary and could also include a spring to bias the access door 78 in a closed position, where the door 78 is substantially aligned with the surface of the ridge handle 62. Cutouts 82 are provided in the ridge handle 62 to facilitate movement of the access door 78 from a closed position to an open position without adding additional structure to either part. As before, there are an infinite number of variations and design modifications that could provide limited access to the access hole 76, and as such, this disclosure is not intended to be limiting.

The use of the access hole to enable the device 14 to be used as a cutting device is depicted in FIG. 9. A carrot 84, or any other item of similar size, can be placed through the access hole within the support ridge 48, with the access door 78 in an open position. The longitudinal structure of the support ridge 48 provides a resting surface to support the item 84. The blade 34 can then be lowered to cut the item 84. This figure also shows an alternative adjustment of the positioning mechanism of the raised edge 52 of the support ridge 48 relative to the blade 34. Here the ridge base 86 of the support ridge 48 is received by a bushing 88 that is stationary to the frame 28. The support ridge 48, including the raised edge 52, is able to move closer to or further away from the blade 34 by displacing the ridge handle 62. Placement of the raised edge 52 of the support ridge 48 can be secured in any position by friction between the ridge base 86 and the bushing 88 or by any other locking mechanism that is known in the art.

A powered actuation mechanism is illustrated in FIG. 10. A motor 90 drives a worm 92, which in turn drives a worm gear 94. This combination provides rotary motion of the worm gear 94, and the attached gear arm 96, as depicted by the arrow 98. A roller 100 is rotatably mounted on the end of the gear arm 96, the movement of which translates to movement of the blade 102. The roller 100 articulates intimately with the blade lip 104. When the roller 100 no longer makes contact with the blade lip 104 (as is shown in FIG. 10b) the recoil spring 106 recoils the blade 102 back to a starting position against the stop 108. The gear arm 96 may continue around and stop at the position shown in FIG. 10a, ready to actuate again when the motor is reactivated.

A similar process can also be used where the blade 102 with the gear arm 96 reach the bottom of the stroke (as shown in FIG. 10b) and the motor stops and reverses. This drives the gear arm 96 in the direction of the second arrow 110, back up to the starting position (FIG. 10a). In this use of the drive, the roller 100 can be slidably mounted to the blade 102, thus enabling the blade 102 to be pushed down and pulled up. This combination would eliminate the need for the recoil spring 106. This again is only one of a virtually infinite number of drive systems that could be used to actuate the blade 102 in the disclosed invention. As such, this particular system is not intended to be limiting to the scope of the invention.

The side view of another alternative form of the invention is shown in FIG. 11 and a front view is shown in FIG. 12. In this form, the invention includes a substantially hollow frame 112 that is rectangular in shape as opposed to partially arcuate substantially hollow frame as in the previous figures. This is because the cutter 114 is now slidably mounted to the frame 112 rather than pivotally mounted, as in the previous figures. The cutter 114 is mounted to sliders 116, which ride on rods 118. The cutter 114 is articulated by use of a handle 120, which is also mounted to the sliders 116. The internal mechanism of the invention, including the support ridge 48 and the item support 50 are functionally identical to that as previously disclosed.

The access door 122 is shown to be pivotally mounted to the frame 112 near the base, and therefore opens at the top end. The cutter 114 is depicted to be at rest in the bottom, or lower position with the cutting surface of the cutter 114 facing up. This is done for convenience and safety. The door 122 can easily be opened, and gravity will keep it open, as the user's hand is placed within the device. Since the cutter is also in the lowered position, gravity prevents it from accidentally becoming dislodged with the user's hand inside. A safety guard 124 is used to prevent the door from opening while the cutter 114 is raised. The functional qualities of the rest of the device are similar to those previously noted in this disclosure.

The mechanization of the cutting process can be made in a number of methods. In FIG. 13a a starting position is shown which, as previously noted, allows for the access door 122 to be opened. In FIG. 13b, the same device is shown in an active cutting position with the access door 122 closed. In both figures, a slidably mounted cutter 126 is slidably mounted on the pair of rods 118. A rotary blade 128 is rotatably mounted on the upright 130, which is then supported by the sliders 116 riding on the rods 118. This combination allows for free movement of the blade 128 across the item support 50, which supports the item to be cut or sliced.

Rotation of the blade 128 can be by hand, but it is most advantageous to use a power plant such as a motor 132. In this version of the invention, the motor 132 is secured to the upright 130 and mechanically connected to the blade 128 by a drive pulley 134 that actuates a belt 136. At the other end of the belt 136, a second pulley 138 is coupled to the blade 128. Thereby, rotation of the motor 132 results in rotary movement of the blade 128, as designated by the arrow 140.

A switch 142 is shown on the handle 120. The user can depress the switch 142, thereby closing an electrical circuit between a power supply and the motor 132, actuating the blade 128. A normally open limit switch (not shown) on the door could be used in series with the switch 142 and motor 132 circuit. If the access door 122 is open, the circuit between the motor 132 and the power supply remains open. This adds a safety feature to ensure the inability of the blade to run with if a user's hand could be within the device.

A skirt 144 also guards the blade 128 when the blade 128 is in a retracted position (as shown in FIG. 13a). This retracted position is the only position of the blade possible in which the access door 122 can be opened. This is due to the interference caused by the safety guard 124 and the door 122. This is done in accordance with the device as shown in FIG. 11. This duel safety is not critical to the invention, but is a preferred feature of the device.

It is to be understood that all of the enclosed information as presented is as the preferred embodiment in some form, as seen by the inventor. An infinite number of variations and modifications can be made including the sizing and positioning of various elements of the device including the blade, the form of the support ridge, the type of adjustment and mechanism to enable driving the cutting blade.

What is claimed is:

1. A poultry deboning device comprising:
a frame including a support ridge;
an item support positioned opposite to said support ridge; and
a cutting blade positioned between said support ridge and said item support, the blade movably mounted to said frame.

2. The device as described in claim 1, further comprising a handle that is mounted to said cutting blade, the handle and said blade being movably mounted to said frame.

3. The device as described in claim 2, wherein said handle and said blade are movably mounted by a mounting selected from the group consisting of pivotally mounted, rotatably mounted and slidably mounted.

4. The device as described in claim 2, wherein said frame is further comprised of a substantially hollow structure and a safety lid movably mounted to said structure.

5. The device as described in claim 4, wherein said safety lid is movably mounted to said structure such that said handle can be positioned to interfere with movement of said safety lid from a closed position to an open position.

6. The device as described in claim 1, wherein said blade is movably mounted by a mounting selected from the group consisting of pivotally mounted, rotatably mounted and slidably mounted.

7. The device as described in claim 1, wherein said support ridge is comprised of a raised peripheral edge.

8. The device as described in claim 7, wherein said raised peripheral edge is a raised annular ring.

9. The device as described in claim 7, wherein said support ridge includes an access hole positioned within said raised peripheral edge thereby providing access to said cutting blade through said access hole.

10. The device as described in claim 9, wherein said frame includes an access door which can be positioned adjacent to said access hole, thus selectively blocking access to said blade through said access hole.

11. The device as described in claim 10, wherein said access door is movably mounted to said frame.

12. The device as described in claim 10, wherein said access door is pivotally mounted to said frame.

13. The device as described in claim 1, wherein said support ridge is adjustable in position relative to said cutting blade.

14. The device as described in claim 13, wherein said support ridge is adjustable by use of an adjustment selected from the group consisting of a threaded adjustment and a slide adjustment.

15. The device as described in claim 1, wherein said item support is movably mounted to said frame and includes a substantially flat section.

16. The device as described in claim 15, wherein said item support includes a spring providing bias to said substantially flat section toward said cutting blade.

17. The device as described in claim 15, wherein said substantially flat section includes a textured face.

18. The device as described in claim 15, wherein said substantially flat section includes a plurality of cleats positioned on one face thereof.

19. The device as described in claim 1, wherein said cutting blade is a serrated knife blade.

20. The device as described in claim 1, wherein said device is further comprised of a mechanical drive coupled to said cutting blade.

21. The device as described in claim 20, wherein said mechanical drive includes an electric motor, which actuates a roller, which articulates with said cutting blade.

22. The device as described in claim 21, wherein said electric motor actuates said roller by use of a gear drive.

23. The device as described in claim 20, wherein said mechanical drive includes a spring mounted to said cutting blade thus providing a spring recoil of said cutting blade.

24. The device as described in claim 20, wherein said mechanical drive includes a motor in mechanical communication with said cutting blade causing rotary motion of said cutting blade.

25. A method of separating poultry breast meat from bone including the steps of:
providing a deboning device including:
a frame including a support ridge;
an item support positioned opposite to said support ridge; and
a cutting blade positioned between said support ridge and said item support, the blade movably mounted to said frame;
positioning said poultry breast on said support ridge and securing thereto by force applied by said item support; and
actuating said cutting blade, thus cutting through said poultry breast separating said breast meat from said bone.

26. The method as described in claim 25, wherein the step of adjusting the position of said support ridge relative to the position of said cutting blade.

27. An item securing slicing device comprising:
a frame including an adjustable height support ridge;
an item support positioned opposite to said adjustable height support ridge; and
a cutting blade positioned between said adjustable height support ridge and said item support, the blade movably mounted to said frame.

28. The device as described in claim 27, further comprising a handle that is mounted to said cutting blade, the handle and said blade being movably mounted to said frame.

29. The device as described in claim 28, wherein said handle and said blade are movably mounted by a mounting selected from the group consisting of pivotally mounted, rotatably mounted and slidably mounted.

30. The device as described in claim 27, wherein said frame is further comprised of a substantially hollow structure and a safety lid movably mounted to said structure.

31. The device as described in claim 30, wherein said safety lid is movably mounted to said structure such that said handle can be positioned to interfere with movement of said safety lid from a closed position to an open position.

32. The device as described in claim 27, wherein said support ridge is comprised of a raised peripheral edge.

33. The device as described in claim 32, wherein said raised peripheral edge is a raised annular ring.

34. The device as described in claim 32, wherein said support ridge includes an access hole positioned within said raised peripheral edge thereby providing access to said cutting blade through said access hole.

35. The device as described in claim 34, wherein said frame includes an access door which can be positioned adjacent to said access hole, thus selectively blocking access to said blade through said access hole.

36. The device as described in claim 35, wherein said access door is movably mounted to said frame.

37. The device as described in claim 27, wherein said adjustable height support ridge is adjustable relative to said cutting blade.

38. The device as described in claim 37, wherein said support ridge is adjustable by use of an adjustment selected from the group consisting of a threaded adjustment and a slide adjustment.

39. The device as described in claim 27, wherein said item support is movably mounted to said frame and includes a substantially flat section.

40. The device as described in claim 39, wherein said item support includes a spring providing bias to said substantially flat section toward said cutting blade.

41. The device as described in claim 39, wherein said substantially flat section includes a textured face.

42. The device as described in claim 39, wherein said substantially flat section includes a plurality of cleats positioned on one face thereof.

43. The device as described in claim 27, wherein said cutting blade is a serrated knife blade.

44. The device as described in claim 27, wherein said device is further comprised of a mechanical drive coupled to said cutting blade.

45. The device as described in claim 44, wherein said mechanical drive includes an electric motor, which actuates a roller, which articulates with said cutting blade.

46. The device as described in claim 45, wherein said electric motor actuates said roller by use of a gear drive.

47. The device as described in claim 44, wherein said mechanical drive includes a spring mounted to said cutting blade thus providing a spring recoil of said cutting blade.

48. The device as described in claim 44, wherein said mechanical drive includes a motor in mechanical communication with said cutting blade causing rotary motion of said cutting blade.
